(19) United States
(12) Patent Application Publication
(10) Pub. No.: US 2021/0263960 A1
(43) Pub. Date: Aug. 26, 2021

(54) INFORMATION PROCESSING DEVICE, INFORMATION PROCESSING SYSTEM, AND NON-TRANSITORY RECORDING MEDIUM

(71) Applicants: Ryo OGAWA, Kanagawa (JP); Masahiro MITSUHASHI, Tokyo (JP); Yohhei OHMURA, Kanagawa (JP); Akito MORITA, Kanagawa (JP)

(72) Inventors: Ryo OGAWA, Kanagawa (JP); Masahiro MITSUHASHI, Tokyo (JP); Yohhei OHMURA, Kanagawa (JP); Akito MORITA, Kanagawa (JP)

(73) Assignee: Ricoh Company, Ltd., Tokyo (JP)

(21) Appl. No.: 17/142,515

(22) Filed: Jan. 6, 2021

(30) Foreign Application Priority Data
Feb. 25, 2020 (JP) 2020-029639

(51) Int. Cl. G06F 16/35; G06F 16/335; G06F 16/332; G06F 16/31; G06F 16/38

(52) U.S. Cl. CPC G06F 16/355; G06F 16/335; G06F 16/38; G06F 16/313; G06F 16/3329

(57) ABSTRACT

An information processing device includes circuitry that acquires a message to be transmitted to a transmission destination and user information of the transmission destination. The circuitry obtains a piece of information indicating a specialty from the message. The circuitry stores, in a memory, the piece of information indicating the specialty in association with the user information of the transmission destination. The circuitry searches for a user, in response to an inquiry related to a target specialty and according to content of the inquiry, based on one or more pieces of information indicating one or more specialties including the piece of information indicating the specialty. The one or more pieces of information are previously stored in the memory.

### CROSS-REFERENCE TO RELATED APPLICATION

This patent application is based on and claims priority pursuant to 35 U.S.C. § 119(a) to Japanese Patent Application No. 2020-029639, filed on Feb. 25, 2020, in the Japan Patent Office, the entire disclosure of which is hereby incorporated by reference herein.

### BACKGROUND

### Technical Field

Embodiments of the present disclosure relate to an information processing device, an information processing system, and a non-transitory recording medium storing instruction for executing a method of processing information.

### Related Art

In social networking services (SNS) and the like, a tag function for registering a word indicating a specialty of a user is known. By using such a tag function, a user who has specialized knowledge, which is desired knowledge, may be searched.

However, in a conventional tag function, because manually adding a word that indicates a specialty of a user, the user may fail to add a tag, or may add tags excessively to exaggerate his or her specialty. Due to this, whether the user has specialized knowledge, which is desired knowledge, or not may not be determined correctly.

To deal with this, there is a technique, in which a word, which is to be a tag, is extracted from a document in which a user is involved, and the word is presented as the tag indicating a specialty of the user.

### SUMMARY

An exemplary embodiment of the present disclosure includes an information processing device including circuitry. The circuitry acquires a message to be transmitted to a transmission destination and user information of the transmission destination. The circuitry obtains a piece of information indicating a specialty from the message. The circuitry stores, in a memory, the piece of information indicating the specialty in association with the user information of the transmission destination. The circuitry searches for a user, in response to an inquiry related to a target specialty and according to content of the inquiry, based on one or more pieces of information indicating one or more specialties including the piece of information indicating the specialty. The one or more pieces of information are previously stored in the memory.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example configuration of an information processing system according to one or more embodiments;

FIG. 2 a block diagram illustrating an example of a hardware configuration of a management server according to one or more embodiments;

FIG. 3 is a block diagram illustrating an example of a functional configuration of a management server according to one or more embodiments;

FIG. 4 is a diagram illustrating an overview of a process performed by an information processing system according to one or more embodiments;

FIG. 5 is a sequence diagram illustrating an example of a process performed by an information processing system according to one or more embodiments;

FIG. 6 is a diagram illustrating an example of a message input screen, according to one or more embodiments;

FIG. 7 is a diagram illustrating an example of a thank-you message input in a screen, according to one or more embodiments;

FIG. 8 is a diagram illustrating a method of extracting tags from a thank-you message and storing the extracted tags, according to one or more embodiments;

FIG. 9 is a diagram illustrating an example case in which a tag that is same with previous one is to be stored, according to one or more embodiments;

FIG. 10 is a diagram illustrating an example of a posted question, according to one or more embodiment;

FIG. 11 is a diagram illustrating a method of extracting words from a question and searching for a recommended specialist, according to one or more embodiments;

FIG. 12 is a diagram illustrating a method of setting order of priority to a plurality of users based on total scores, according to one or more embodiments;

FIG. 13 is a diagram illustrating a method of determining a priority using a score and a last update date, according to one or more embodiments;

FIG. 14 is a diagram illustrating tag degradation, according to one or more embodiments;

FIG. 15 is a diagram illustrating replacement of tags, according to one or more embodiments; and

FIG. 16 is a diagram illustrating another example configuration of an information processing system according to one or more embodiments.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operation in a similar manner, and achieve a similar result.

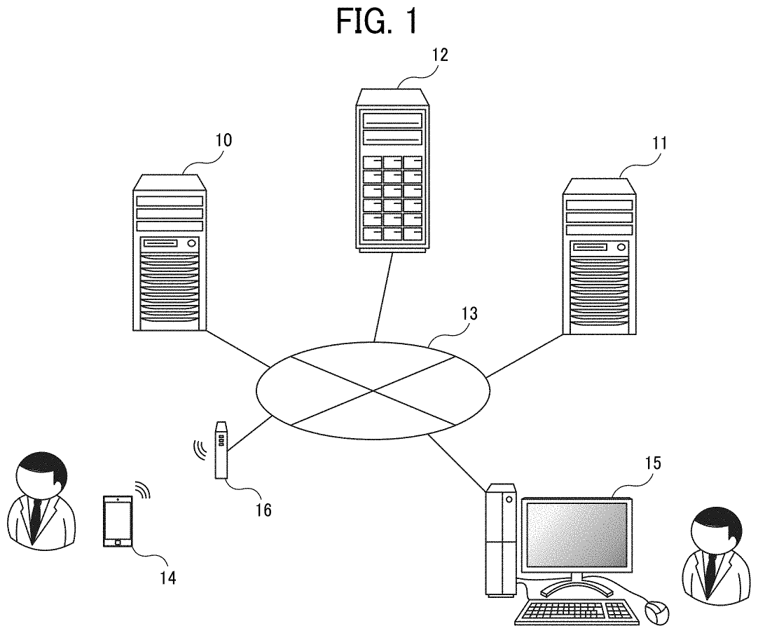

FIG. 1 is a diagram illustrating an example configuration of an information processing system according to a first embodiment of the disclosure. The information processing system according to the first embodiment includes a message processing device that receives a message, an information providing device that receives an inquiry, or a question, and provides information on a user who is recommended as a respondent to the inquiry, or the question, and an information processing device that manages the message processing device and the information providing device.

Hereinafter, the message processing device is referred to as a thank-you message server 10, the information providing device is referred to as a specialist recommendation server 11, and the information processing device is referred to as a management server 12, but these devices are not limited to the servers. In the present embodiment, the information processing system includes three servers, each of which has one of the functions which are divided into three functions, but this is not the limiting. In some embodiments, the information processing system may include a single server that has all the functions combined together, the information processing system may include two servers each of which has one of the functions which are divided into two functions, or the information processing system may include four or more servers each of which has one of the functions which are divided into four or more functions, for example.

The thank-you message server 10, the specialist recommendation server 11, and the management server 12 are connected to a network 13 and communicate with each other through the network 13. The network 13 may be either a wired network or a wireless network. The network 13 is implemented by a single network or two or more networks that are connected to one another via a router or a proxy server, for example. Further, communication terminals 14 and 15 used by User A (Mr. A) and User B (Mr. B), respectively, are connected to the network 13. In the example illustrated in FIG. 1, the number of the communication terminals 14 and 15 connected to the network 13 is two, but the number of communication terminals 14 and 15 connected to the network 13 may be three or more. Further, another device may be connected to the network 13.

The thank-you message server 10 implements an application for using a thank-you message sending service. The thank-you message sending service has a function of sending a thank-you message to the management server 12. In addition, the thank-you message sending service provides an input screen for a message to a user who uses the service. On the input screen, the user specifies a person to whom the thank-you message is to be sent, inputs a message, and sends the message to the thank-you message server 10.

The specialist recommendation server 11 implements an application for using a specialist recommendation service. The specialist recommendation service, for example, receives an inquiry (question) from User A via the communication terminal 14, and provides the information on a recommended user as a specialist. In the description of the present embodiment, User B who uses the communication terminal 15 is recommended, as an example. The specialist recommendation service transmits user information of User B to the communication terminal 14 used by User A to notify the User A of a recommended specialist, User B, who is to answer the question. In addition, the specialist recommendation service transmits to the communication terminal 15 used by User B a notification indicating that User B has been recommended as a specialist to answer the question of User A. The specialist recommendation service may also notify User B of a question from User C (Mr. C).

User C may ask a question to User B by meeting face-to-face or by, for example, e-mail, and obtain an answer for the question. After obtaining the answer, User C may send a thank-you message to User B.

Each of the communication terminals 14 and 15 may be any device as long as the device has a communication function and capable of sending and receiving messages. Examples of each of the communication terminals 14 and 15 include a notebook personal computer (PC), a mobile phone, a smartphone, a tablet terminal, a game machine, a personal digital assistant (PDA), a digital camera, a wearable PC, a desktop PC, a multifunction peripheral (MFP), a projector (PJ), an interactive whiteboard (IWB), which is a white board having an electronic whiteboard function that enables mutual communications, and the like. When being devices that communicate wirelessly, the communication terminals 14 and 15 may be connected to the network 13 via a relay device 16 such as a router.

The management server 12 communicates with the thank-you message server 10 and the specialist recommendation server 11, receives a thank-you message from the thank-you message server 10, and searches for a recommended user as a specialist with the specialist recommendation server 11. The management server 12 stores a message, extracts, or obtains from the message a piece of information indicating a specialty as a tag, and stores the tag in association with corresponding user information. The tag, which is the piece of information, indicates a skill of a user and is used as material for searching for a user who is able to give an appropriate answer to a technical (specialized) question when the question is received.

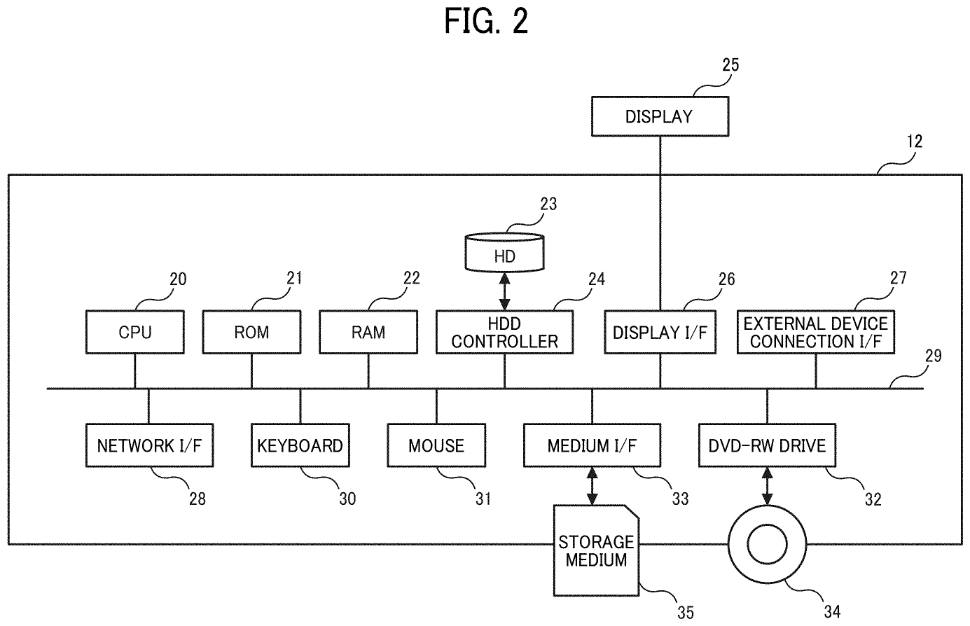

FIG. 2 is a block diagram illustrating an example of a hardware configuration of the management server 12 according to the present embodiment of the disclosure. Since each of the thank-you message server 10, the specialist recommendation server 11, and the communication terminals 14 and 15 has substantially the same hardware configuration as the management server 12, a description of the hardware configuration of each of these servers and terminals is omitted.

The management server 12 includes, as hardware, a central processing unit (CPU) 20, a read only memory (ROM) 21, a random access memory (RAM) 22, a hard disk (HD) 23, and a hard disk drive (HDD) controller 24. The management server 12 further includes a display interface (I/F) 26, an external device connection I/F 27, a network I/F 28, a data bus 29, a keyboard 30, a pointing device (mouse) 31, a digital versatile disc rewritable (DVD-RW) drive 32, and a medium I/F 33. In the example of the present embodiment, a display 25 is provided as being separated from the management server 12, but this is not limiting. In one or more embodiments, the display 25 may be included in the management server 12.

The CPU 20 controls the management server 12 and serves as a processor to perform the overall operation of the management server 12. The ROM 21 stores programs such as an initial program loader (IPL) to boot the CPU 20. The RAM 22 provides a work area for the CPU 20. The HD 23 stores programs such as applications and various data. The HDD controller 24 reads and writes various data from and to the HD 23 under control of the CPU 20.

The display 25 displays various types of information such as a cursor, a menu, a window, characters, or an image. The display I/F 26 is an interface for connecting the display 25. The external device connection I/F 27 is an interface for connecting various external devices. Examples of the external devices include, but are not limited to, a universal serial bus (USB) memory and a printer. The network I/F 28 is an interface for performing data communication using the network 13. Examples of the data bus 29 include, but not limited to, an address bus and a data bus, which electrically connects the components, including such as the CPU 20, with one another.

The keyboard 30 is one example of an input device provided with a plurality of keys for enabling a user to input characters, numerals, or various instructions. The pointing device 31 is another example of an input device for enabling a user to select or execute a specific instruction, select a target for processing, or move a cursor being displayed. The DVD-RW drive 32 reads and writes various data from and to a DVD-RW 34, which is an example of a removable storage medium (recording medium). The removable storage medium is not limited to the DVD-RW and may be a digital versatile disc-recordable (DVD-R) or the like. The medium I/F 33 controls reading or writing (storing) of data with respect to a storage medium (recording medium) 35 such as a flash memory.

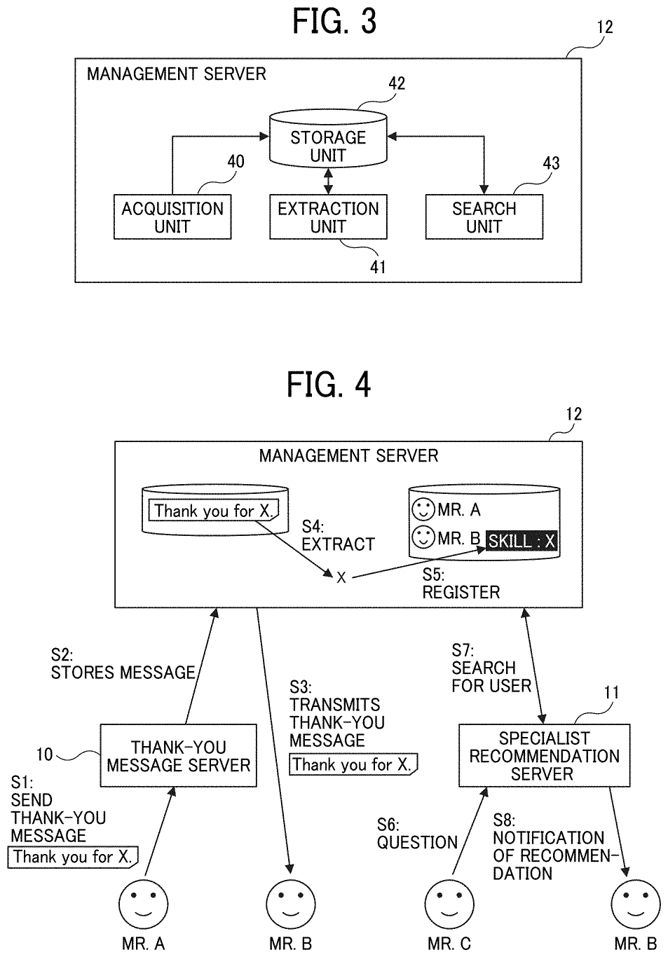

FIG. 3 is a block diagram illustrating an example of a functional configuration of the management server 12, according to the present embodiment of the disclosure. Each of the functions of the management server 12 is implemented by a corresponding functional unit that is generated by the CPU 20 reading a program stored in the HD 23 into the RAM 22 and executing the program. Accordingly, the management server 12 includes various functional units each of which implements a corresponding function. In the present embodiment, each of the functional units (functions) is implemented by executing the program. However, the present disclosure is not limited to this, and a part or all of the functional units (functions) may be implemented by hardware such as a circuit (circuitry). Examples of such a circuit include an application specific integrated circuit (ASIC), a digital signal processor (DSP), and a field programmable gate array (FPGA).

The management server 12 includes, as functional units, an acquisition unit 40, an extraction unit 41, a storage unit 42, and a search unit 43. The acquisition unit 40 communicates with the thank-you message server 10 and receives a message from the thank-you message server 10 along with user information of a transmission destination of the message. The message is a message including words of gratitude, and the user information of the transmission destination includes, for example, a user name. The acquisition unit 40 functions as a message transmission/reception unit, and capable of transmitting the received message to the transmission destination.

The extraction unit 41 analyzes the message acquired by the acquisition unit 40 and extracts information indicating a specialty from the message. The extraction unit 41 extracts, or obtains, one or more pieces of information indicating one or more specialties from the message as one or more tags.

The storage unit 42 stores the messages acquired by the acquisition unit 40 and the one or more tags extracted by the extraction unit 41. Each tag is stored in association with the user information of the transmission destination acquired by the acquisition unit 40. The message is delible from the storage unit 42 after the one or more tags are extracted by the extraction unit 41. This prevents the storage capacity of the management server 12 from being lack of space.

The search unit 43 receives a search request from the specialist recommendation server 11 and searches for a user from the information stored in the storage unit 42. The search request includes a question related to a specialty (target specialty) received by the specialist recommendation server 11. Accordingly, the search unit 43 searches for user information whose tags match one or more words included in the question, based on content of the question. The search unit 43 transmits the searched user information to the specialist recommendation server 11.

A description is given below of an overview of how the information processing system is used with reference to FIG. 4. FIG. 4 is a diagram illustrating an overview of a process performed by the information processing system according to the present embodiment of the disclosure. For example, User A uses a communication terminal used by User A to specify a destination to User B and send a thank-you message, “Thank you for X” (S1). The thank-you message server 10 transmits the thank-you message received from User A to the management server 12.

When acquiring the thank-you message, the management server 12 stores the thank-you message in a database (DB) that serves as the storage unit 42 in association with the user information (of User B) (S2). The management server 12 transmits the thank-you message to User B who is the transmission destination (S3).

The management server 12 analyzes the acquired thank-you message, “Thank you for X”, extracts a word of “X” as a tag (tag “X”) (S4), and registers the tag X in the DB (S5). The DB stores the extracted tags each of which is associated with a user and manages data for each user. In the example of the present embodiment, the tag “X” is associated with User B. Suppose that User C has a question about “X”. User C uses a communication terminal used by User C to transmit, to the specialist recommendation server 11, a question, “Can you explain about X?” (S6) The specialist recommendation server 11 transmits the question to the management server 12 and requests to search for a recommended user as a specialist (transmits a search request).

Upon receiving the search request, the management server 12 searches for an appropriate user from the information stored in the DB based on the content of the question (S7). Since the content of the question includes a noun of “X”, the user information associated with the tag “X” is searched. The user information of User B associated with the tag “X” is stored in the DB. Accordingly, the management server 12 transmits the user information of User B to the specialist recommendation server 11.

The specialist recommendation server 11 notifies User C of the user information (of User B), which is searched by the management server 12, and notifies User B that User B has been recommended as a specialist, namely transmits to User B a notification of the recommendation (S8). User C may obtain an answer to the question from User B by meeting face-to-face or by using e-mail, for example.

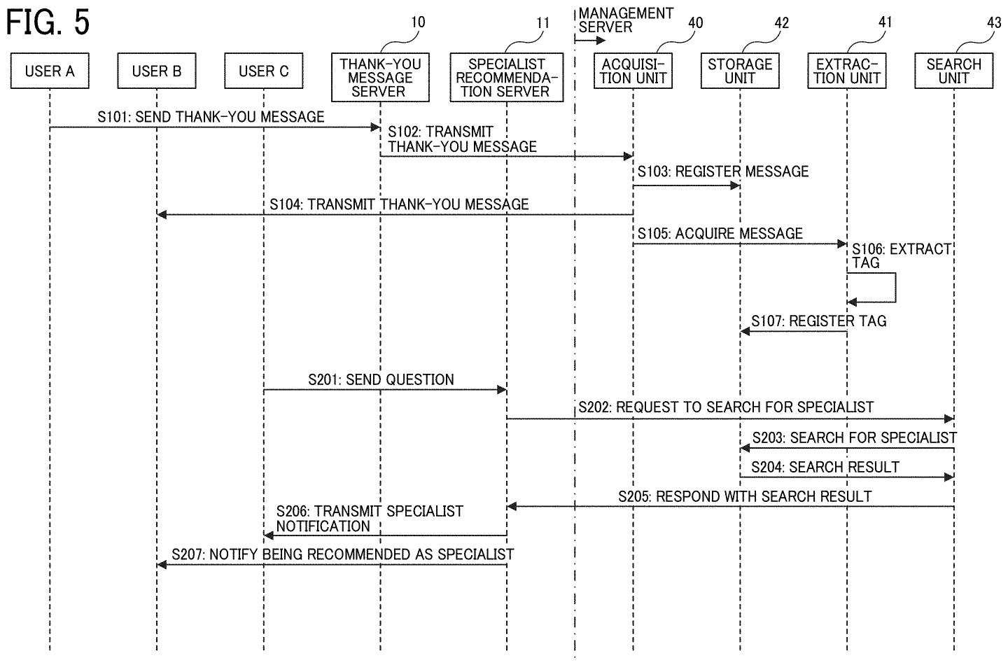

A detailed description is given of a process performed by the information processing system according to the present embodiment with reference to FIG. 5. User A generates a thank-you message using a communication terminal, specifies a transmission destination, and sends the generated message to the thank-you message server 10 (S101). The user information of the transmission destination is specified as “To: B” in the message, for example. The thank-you message server 10 transmits the received message to the management server 12 (S102). The acquisition unit 40 of the management server 12 receives and acquires the message from the thank-you message server 10.

The acquisition unit 40 stores (registers) the acquired message in the storage unit 42 (S103), and transmits the message to User B specified as the transmission destination (S104). The extraction unit 41 acquires the message from the acquisition unit 40 (S105), analyzes the message, and extracts a tag (S106). The extraction unit 41 stores (registers) the extracted tag in the storage unit 42 in association with user information (S107).

When, for example, being in a situation to require advice, User C generates a question using a communication terminal and sends the question to the specialist recommendation server 11 (S201) in order to make the specialist recommendation server 11 recommend a specialist who is familiar with the situation, or who is capable of dealing with the situation. When receiving the question from User C, the specialist recommendation server 11 requests the search unit 43 of the management server 12 to search for a specialist to be recommended to User C (S202).

The search unit 43 analyzes the content of the question, divides the question into words, collates each word with the tags stored in the storage unit 42, and searches for user information associated with the tag matching the word (S203). In the example of the present embodiment, the user information of User B is obtained as a search result (S204). The search unit 43 transmits the user information of User B as the search result to the specialist recommendation server 11 (S205).

The specialist recommendation server 11 receives the search result from the search unit 43, and notifies User C, who is a sender of the question, of the user information of User B as information on a recommended specialist, namely transmits to User C a notification about a specialist (which may be referred to as specialist notification) (S206). In addition, the specialist recommendation server 11 notifies User B that User B has been recommended to User C as a specialist (S207).

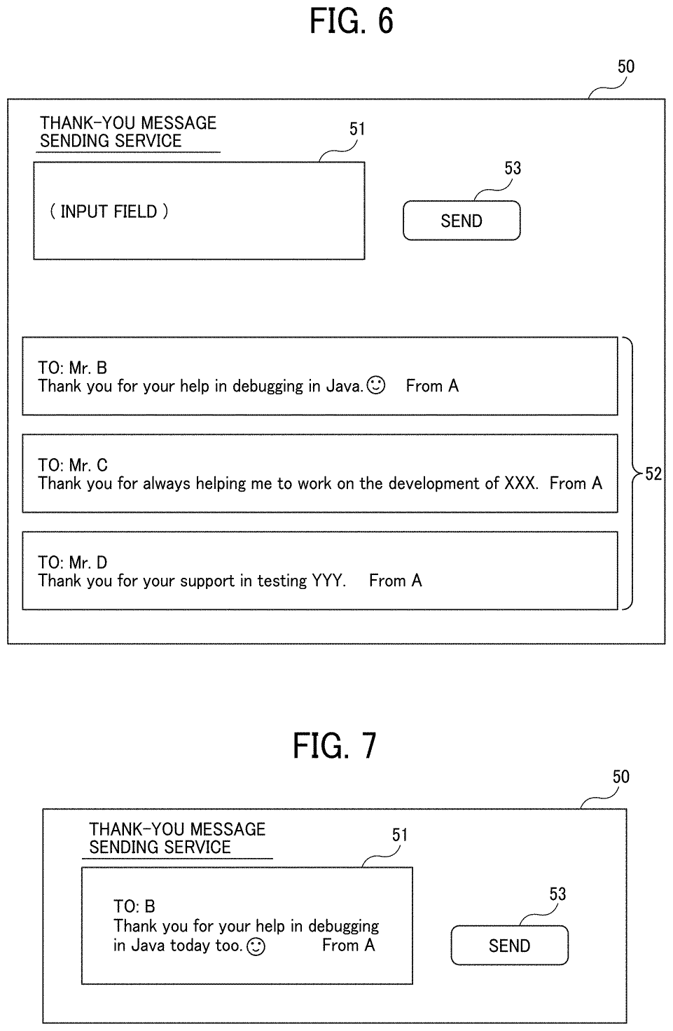

A description is given below of an input screen displayed on the communication terminal used by User A to generate and send the thank-you message in S101 of FIG. 5, with reference to FIG. 6. FIG. 6 is a diagram illustrating an example of a message input screen, according to the present embodiment. An input screen 50 provided by the thank-you message sending service includes an input field 51 for inputting a thank-you message, a sent message list 52 for displaying a list of messages that are previously input and sent, and a send button 53.

In the input field 51, user information of a transmission destination, a thank-you message, and user information of a transmission source are input. For example, as each message displayed in the sent message list 52, the thank-you messages include words indicating technical (specialized) words (terminologies), such as “Java (registered trademark”, “debugging”, “development”, etc.

Referring to the sent message list 52 allows User A to check what kind of messages have been transmitted in the past.

A thank-you message is generated and sent when an event, a situation, or a case in which a user appreciates occurs. The thank-you message includes a word of gratitude, “thank you,” along with words indicating what the user is thankful for, namely, words indicating (to express) appreciation of a user who generates the message. In a case of a thank-you message of “Thank you for explaining me about XX”, “XX” is a target word and indicating regarding what for the user is thankful for. When a thank-you message is sent in a business scene, etc., a word indicating a specialty is often included, or used, in the message as the target word.

Such technical (specialized) words change from day to day due to the emergence of new technologies, trends or the like, and content of the thank-you message also changes, accordingly. By analyzing the thank-you messages and accumulating, or storing, the words indicating a specialty as tags in association with corresponding user information, information indicating which user is currently familiar with a certain field may be managed. This results in data freshness regarding a specialty of each user.

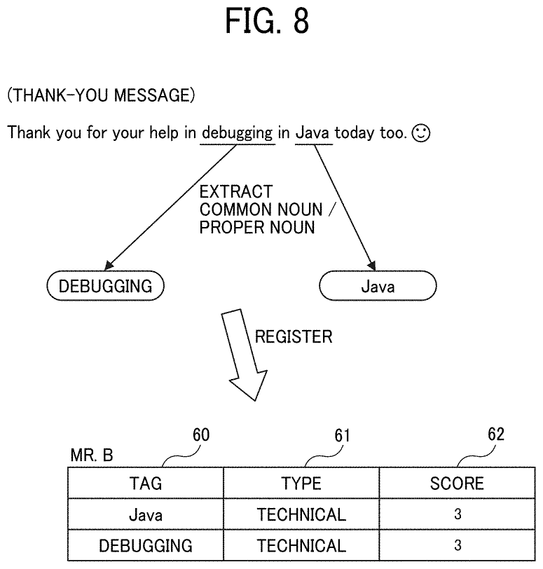

A description is given below of a method of extracting words indicating a specialty and storing each word in association with user information, with reference to FIG. 7 and FIG. 8. FIG. 7 is a diagram illustrating an example of a thank-you message input in an input screen, according to the present embodiment of the disclosure. FIG. 8 is a diagram illustrating a method of extracting tags from the thank-you message illustrated in FIG. 7 and storing the extracted tags, according to the present embodiment of the disclosure.

An extraction as a tag (tag extraction) is performed on a message part, but not on parts of “To: Mr. B”, which is the transmission destination (receiver), and “from A”, which is the transmission source (sender). The message part includes a symbol, and word(s) of “today”, “too”, and “thank you for helping me”, etc., which are not common nouns or proper nouns. The common nouns and the proper nouns are to be extracted as tags. For example, the message part is divided into words by morphological analysis to extract a word that is a common noun or a proper noun. Since the morphological analysis is a well-known analysis method, a detailed description of the morphological analysis is omitted here.

In the message illustrated in FIG. 7, two words “Java” and “DEBUGGING” are extracted as one of a common noun and a proper noun as illustrated in FIG. 8.

Since the destination of the thank-you message is Mr. B, the two extracted words are stored as tags in association with Mr. B. Each tag is stored in a table that is associated with Mr. B. The table has a tag field 60 for storing tags, a type field 61 indicating a type of a corresponding word, and a score field 62 indicating a score of a corresponding tag. The extracted tags “Java” and “DEBUGGING” are stored in the tag field 60. In the type field 61, “TECHNICAL” indicating a type of the tag is stored.

The types of tags are classifiable into “GENERAL” and “TECHNICAL” depending on whether each tag corresponds to a general noun such as, for example, “river”, “mountain”, and “sea” or not. Whether a general noun or not is determinable by whether a word corresponds to one of the nouns registered as general nouns. However, the above-described method is an example and not limiting the disclosure, and the classification is not limited to the two type, which is described above.

The score is a value indicating, for example, the number of extractions (how many times a corresponding word is extracted) and given to the extracted tag. In the example of the present embodiment, in a case where the tag is extracted once, a score of 3 is given. The score of 3 is an example of the value, the value may be 1, 2, 4, or another value more than 4.

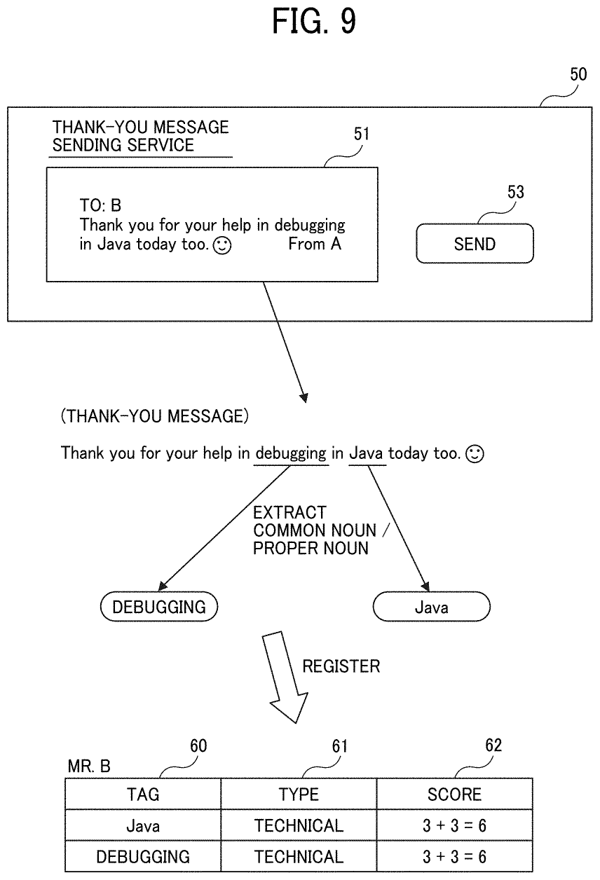

FIG. 9 is a diagram illustrating an example in which a thank-you message is sent to Mr. B after storing the tags, as illustrated in FIG. 8, according to the present embodiment of the disclosure. The content of the message part is the same as the content of the message part illustrated in FIG. 7. Accordingly, the same tags “Java” and “DEBUGGING” are extracted, and the tags are stored.

Since “Java” and “DEBUGGING” are already in the tag field 60 of the table and the types are the same, the score of each score field 62 changes without adding a new record by newly adding a tag in the tag field 60, for example. That is, for each of “Java” and “DEBUGGING”, a value of 3 indicating that the tag is newly extracted is added to the stored value of 3, resulting in updating the score to a value of 6. In order to update a value of the score, the management server 12 may include an update unit that updates the value.

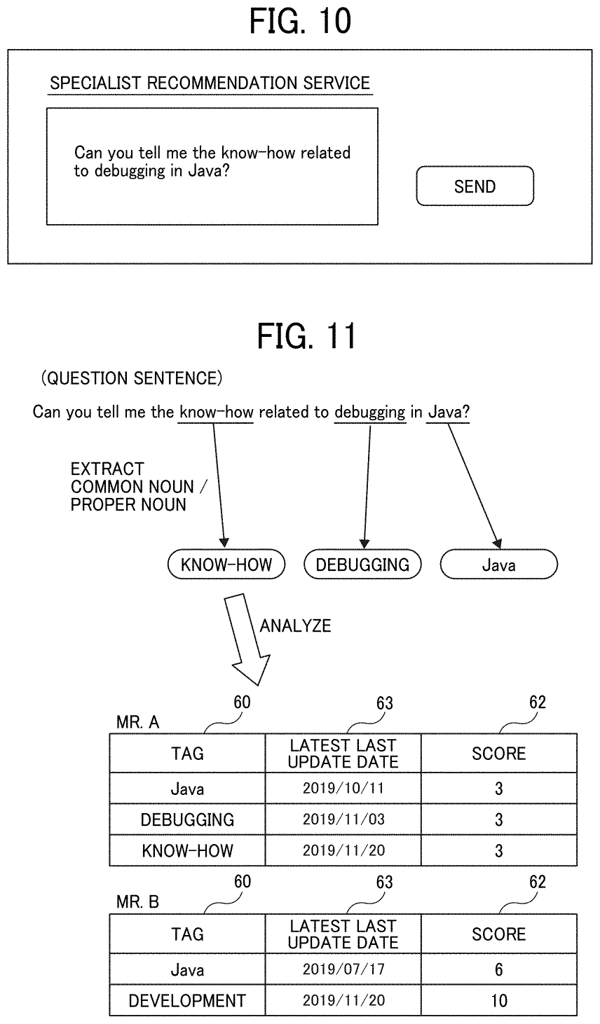

The tags are stored in the table for each user as illustrated in FIG. 8 or FIG. 9. A description is given below of the use of the tags with reference to FIG. 10 to FIG. 12. The tags are used to search for a specialist to be recommended in response to a question, or an inquiry, posted to the specialist recommendation service as illustrated in FIG. 10. Therefore, a transmission destination of the question (inquiry) is the specialist recommendation server 11, which is different from the transmission destination of the thank-you message. The question includes a message part alone. The question may be a natural sentence as illustrated in FIG. 10. Alternatively, the question may be simply one or more keywords.

In substantially the same manner as the thank-you message, the question is analyzed, as illustrated in FIG. 11, and the words corresponding to the common nouns or the proper nouns are extracted. The words may be extracted by the extraction unit 41 in substantially the same manner as when the tags are extracted from the message. In the example of the embodiment, three words “Java”, “DEBUGGING”, and “KNOW-HOW” are extracted.

With reference to the tags stored in the storage unit 42, there are two users, Mr. A and Mr. B, who have tags that match at least one of the three extracted words. Accordingly, Mr. A and Mr. B are candidates to be recommended as specialists.

The specialist recommendation service may recommend a plurality of users as specialists. However, when the plurality of users is recommended as the specialists, the user who posted the question does not know which one of the specialists to select. In order to make it easier for the user to select one of the plurality of users (specialists) as candidates for recommendation, the specialist recommendation service may set order of priority to the plurality of users.

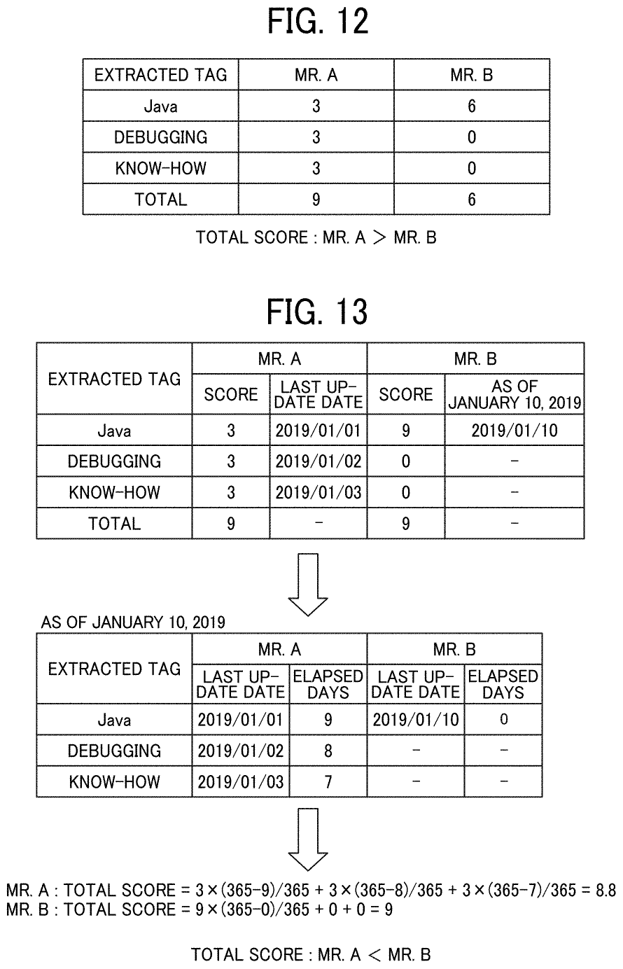

For example, the specialist recommendation service may set the order of priority to the plurality of users (specialists) based on total scores each of which is obtained by adding the scores given to the tags of a corresponding user. FIG. 12 is a diagram illustrating a method of setting the order of priority, according to the present embodiment. The three words “Java”, “DEBUGGING”, and “KNOW-HOW” are extracted from the question. With respect to Mr. A, these three words are stored as tags, and a score value given to each tag is 3. With respect to Mr. B, “Java” is stored as a tag, and a score value given to the tag is 6.

With respect to Mr. A, the total score is 3+3+3=9, and with respect to Mr. B, the total score is 6. Accordingly, Mr. A, who has a total score higher than the other, may be recommended as a specialist with a high priority. This allows the user who posted the question to ask the question to a specialist with a high priority in the order of priority, in order to get an answer.

In the examples described above, the score is given based on the number of extractions (tag extractions). In the above-described case, a specialist who has a total score that is the highest among the specialists (candidates) since many of the scores have been given in the past, but not in the recent past, may be recommended as a specialist. Such a case in which the scores are not given, to the specialist who has the highest total score, in the recent past, may indicate that there is another specialist who is more appropriate than the specialist who has the highest score.

In order to find an appropriate specialist to be recommended, it is desirable to take into account not only the number of tag extractions but also the latest extraction date (how new the tag is). Therefore, in addition to the score field 62, a last update date field 63 for storing the last update date as the latest extraction date may be added to the table for storing the tags. The last update date is the date when a tag is extracted last time, namely, the date when the score is updated the last time.

FIG. 13 is a diagram illustrating a method of determining the order of priority using a score and a last update date, according to the present embodiment. The newer the update date is, the higher the priority may be set. Alternatively, a date when the question is posted may be set as a reference date, and the closer to the reference date the last update date is, the greater the weight is, which result in determining the order of priority by taking the weight into account.

In the example illustrated in FIG. 13, the reference date is set to 2019/01/10, and a validity period du of a tag is set to 365 days. Because the last update date of “Java” related to Mr. A is 9 days before the reference date, the corresponding score value 3 is weighted with (365−9)/365. Similarly, because the last update date of “DEBUGGING” related to Mr. A is 8 days before the reference date, the corresponding value 3 is weighted with (365−8)/365. In addition, because the last update date of “KNOW-HOW” related to Mr. A is 7 days before the reference date, the corresponding value 3 is weighted with (365−7)/365. Accordingly, the total score is 8.8 that is obtained by multiplying each value score by the corresponding weight and adding the value scores together.

On the other hand, because the last update date of “Java” related to Mr. B is the same day as the reference date, the corresponding score value 6 is weighted with 365/365=1, and thereby the total score is 9.

As a result, in terms of the number of extractions alone, Mr. A has a higher priority, but considering the freshness of the tag, Mr. B has a higher priority, and Mr. B is to be recommended as a specialist more appropriate than Mr. A. At this time, Mr. B, who has a high priority, alone may be recommended as a specialist.

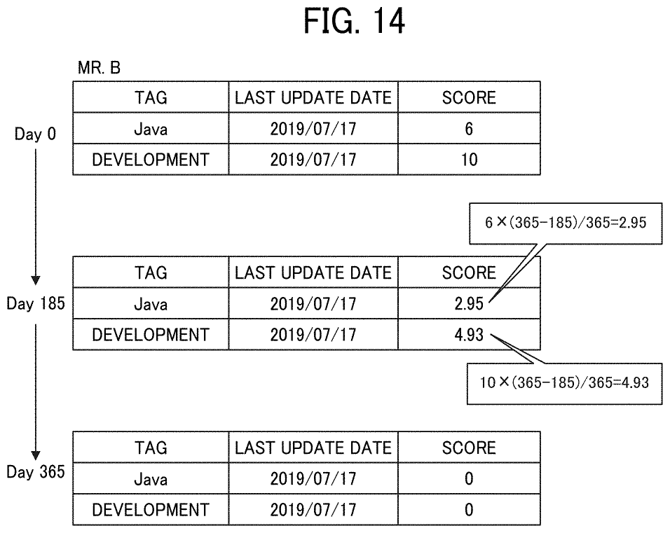

In such calculation of a total score, in which a weight is taken into account, the weight becomes smaller day by day, along the number of days elapsed from the last update date increases, and thereby the score value becomes smaller as well. In the example of FIG. 14, the number of days elapsed from the last update date increases, for example, from Day 0 to Day 185 and from Day 185 to Day 365, the corresponding weight, which starts from 1, changes to, (365−185)/365 and to 0, respectively, so that the score value becomes smaller. The score value becomes 0 when and after 365 days elapses from the last update date. Namely, the score value is updated each time when a date changes. In the description of the embodiment, such a fact, in which the weight decreases and the score value becomes smaller day by day, is referred to as tag degradation.

In the present embodiment, the number of days to be taken for the complete tag degradation is set to 365 days, but the number is not limited to this, and the number of days other than 365 days may be set.

In addition, the weight is not limited to the one calculated by (365−(reference date−last update date))/365, and when a certain number of days or more from the last update date has passed, the last update date may be set to (a x last update date: A>1) and used for a calculation formula so that the newer the last update date is, the weight becomes larger. Since this is an example, the weight may be calculated by using another formula.

Each table associated with a corresponding user and stored and managed in the storage unit 42 may be added data corresponding to a tag field 60, a type field 61, a score field 62, and a last update date field 63 each time a new tag is extracted, but this is not limiting the disclosure. For each user, a maximum limit for the number of tags to be stored and managed may be set. Namely a maximum limit for the number of pieces of information indicating one or more specialties may be set. When the maximum limit is to be exceeded, the tag with the oldest last update date may be deleted, and then the newly extracted tag may be stored in the tag field 60, and the like in which data corresponding to the deleted tag was previously stored. Namely, the pieces of information is deleted in an ascending order of the latest extraction date, when the maximum limit is to be exceeded.

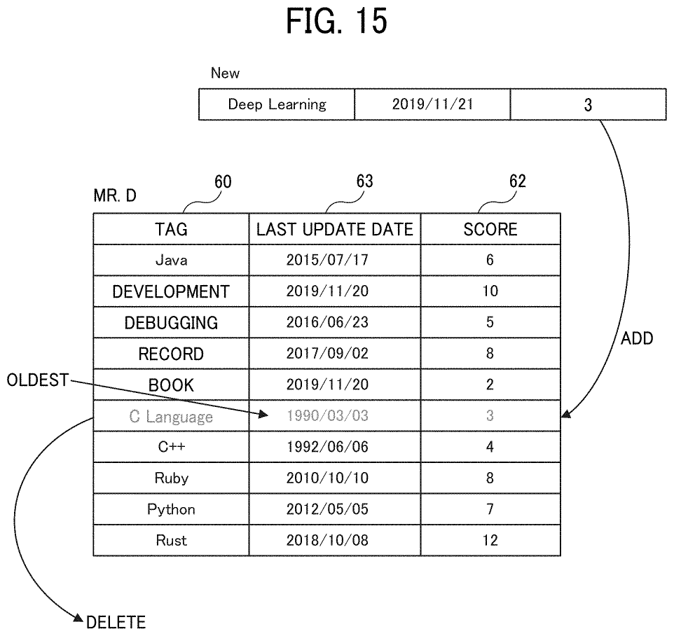

FIG. 15 is a diagram illustrating a method of determining a maximum limit for the number of tags to be stored and managed and deleting an old tag, according to the present embodiment. In the example illustrated in FIG. 15, a table associated with Mr. D (User D) is configured so as to store tags up to 10.

When the management server 12 acquires a thank-you message for Mr. D and extracts “Deep Learning” as a new tag, the management server 12 refers to the table associated with Mr. D to determine whether the number of tags stored and managed is equal to the maximum limit or not. In the example illustrated in FIG. 15, since the maximum limit has been reached, the management server 12 searches the table for the tag having the oldest last update date. In the example illustrated in FIG. 15, since the tag of “C Language” is the oldest, the record is deleted so that “C Language”, “1990/03/03” and “3” are deleted from the tag field 60, the last update date field 63, and the score field 62, respectively. Then, a record for the newly extracted tag is stored. Namely, “Deep Learning” as a data item of tag, “2019/11/21” as a data item of last update date, and “3” as a data item of score are stored in a corresponding filed.

As a result, from the table associated with Mr. D, the tag “C Language” corresponding to a word indicating a specialty is deleted, and the tag “Deep Learning” is added as a new word indicating a specialty.

As described above, the information processing system according to the present embodiment includes the thank-you message server 10, provides a user with an input screen for inputting a thank-you message, and transmitting the thank-you message received from the user to the management server 12, but this is not limiting the disclosure. In one or more embodiments, the thank-you message may be sent by e-mail or the like, and the e-mail sent to a mail server may be acquired, and the message included in the acquired e-mail may be analyzed to extract a tag.

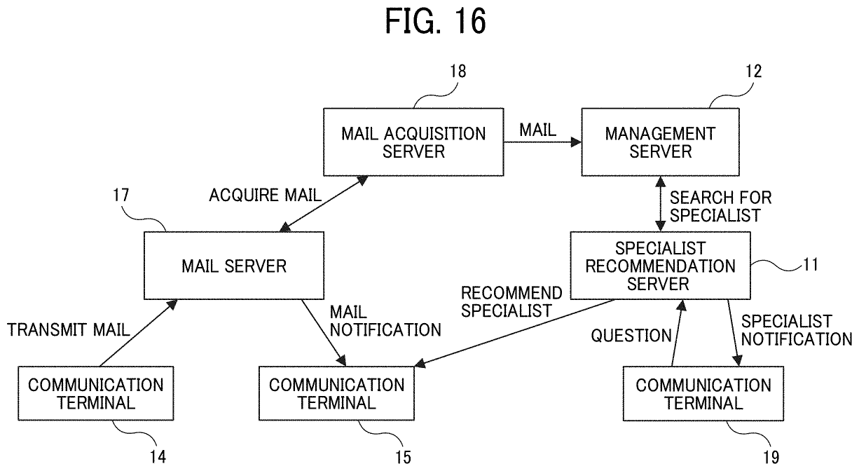

An example configuration of the information processing system according to another embodiment, which is the example described above, in FIG. 16 When transmitting a thank-you message to the communication terminal 15 by e-mail, the communication terminal 14 transmits an e-mail to a mail server 17 instead of the thank-you message server 10. Since the management server 12 is not capable of acquiring the mail, the information processing system separately includes a mail acquisition server 18.

The mail acquisition server 18 inquires the mail server 17 whether a mail is received, and when the mail server 17 receives the mail, the mail acquisition server 18 acquires the mail from the mail server 17. The mail acquisition server 18 transmits the acquired mail to the management server 12. The management server 12 analyzes the mail and extract a tag and user information of the transmission destination to be stored in association with each other.

The specialist recommendation server 11 receives a question posted from a communication terminal 19, requests the management server 12 to search for a specialist, and receives a search result from the management server 12. The specialist recommendation server 11 notifies the communication terminal 19 of the information of the user recommended as a specialist, and notifies the communication terminal 15 that the recommendation as a specialist is made.

As long as the management server 12 is capable of acquiring a message and extract the information indicating a specialty, the message is not limited to the thank-you message or not limited to be transmitted by the e-mail, and any message may be used, and any configuration for acquiring the message may be used.

As described above, tags each of which is information indicating a specialty are extracted from messages that are exchanged on a daily basis and stored. The stored tags are used to search for a specialist who is to answer a question. By applying this configuration, the information indicating the specialty is updated without troublesome, and data freshness is kept.

In a conventional technique, when a range of documents for extraction is set, newly created documents are not included in the range and the extraction is not performed on the newly created documents, resulting in difficulty to maintain data freshness in searching.

Even when the newly created documents is set to be included in the range of documents for the extraction, updating the setting is required each time, resulting in requiring extra work or troublesome work.

According to the one or more embodiments of the disclosure, a device, a system, and a program that enable to update information indicating a specialty of a user without troublesome work and maintain data freshness are provided.

In the above description, the example embodiments of the information processing apparatus, the information processing system, and the program are described. It is to be noted that the above-described embodiments are not limiting the present disclosure and any deletion, addition, modification, change, etc. may be made within a scope in which a person skilled in the art can conceive including other embodiments. Further, any mode that achieves the functions and effects of the present disclosure is within the scope of the present disclosure.

Aspects of this disclosure may attain a recording medium storing the above program, a server apparatus that stores the above program and provides the program in response to a download request.

Any one of the above-described operations may be performed in various other ways, for example, in an order different from the one described above.

Each of the functions of the described embodiments may be implemented by one or more processing circuits or circuitry. Here, the “processing circuit or circuitry” in the present disclosure includes a programmed processor to execute each function by software, such as a processor implemented by an electronic circuit, and devices, such as an application specific integrated circuit (ASIC), a digital signal processors (DSP), a field programmable gate array (FPGA), and conventional circuit modules arranged to perform the recited functions.

Although the embodiments of the disclosure have been described and illustrated above, such description is not intended to limit the disclosure to the illustrated embodiments. Numerous additional modifications and variations are possible in light of the above teachings. It is therefore to be understood that within the scope of the appended claims, the embodiments may be practiced otherwise than as specifically described herein. For example, elements and/or features of different illustrative embodiments may be combined with each other and/or substituted for each other within the scope of this disclosure and appended claims.

What is claimed is:

1. An information processing device, comprising
circuitry configured to
acquire a message to be transmitted to a transmission destination and user information of the transmission destination,
obtain a piece of information indicating a specialty from the message,
store, in a memory, the piece of information indicating the specialty in association with the user information of the transmission destination; and
search for a user, in response to an inquiry related to a target specialty and according to content of the inquiry, based on one or more pieces of information indicating one or more specialties including the piece of information indicating the specialty, the one or more pieces of information being previously stored in the memory.

2. The information processing device according to claim 1,
wherein the circuitry acquires a thank-you message that is used to express appreciation to a user of the transmission destination, and
obtains at least one word corresponding to at least one of a common noun and a proper noun from the thank-you message as the piece of information indicating the specialty.

3. The information processing device, according to claim 1,
wherein the circuitry stores, in the memory, the piece of information indicating the specialty in association with a value that is determined according to at least one of a number of extractions performed on the piece of information indicating the specialty or a latest extraction date,
wherein, in a case in which a search result indicates a plurality of users, the circuitry determines one from the plurality of users based on the value associated with each piece of information indicating the specialty that matches the content of the inquiry.

4. The information processing device, according to claim 3,
wherein, in a case of determining the one from the plurality of users based on the value determined according to the number of extractions and the latest extraction date, the circuitry updates the value each time when a date changes.

5. The information processing device, according to claim 3,
wherein the memory has a maximum limit for a number of pieces of information indicating one or more specialties to be stored for each user,
and when the circuitry is to store, in the memory, one or more new pieces of information indicating one or more specialties that exceed the maximum limit, the circuitry deletes, from the memory, one or more pieces of information previously stored.

6. The information processing device, according to claim 5,
wherein the circuitry deletes, from the memory, the one or more pieces of information previously stored, in an ascending order of the latest extraction date.

7. An information processing system, comprising
circuitry configured to
acquire a message to be transmitted to a transmission destination and user information of the transmission destination,
obtain a piece of information indicating a specialty from the message,
store, in a memory, the piece of information indicating the specialty in association with the user information of the transmission destination,
search for a user, in response to an inquiry related to a target specialty and according to content of the inquiry, based on one or more pieces of information indicating one or more specialties including the piece of information indicating the specialty, the one or more pieces of information being previously stored in the memory, and
provide a search result indicating the user that is searched.

8. An information processing system, comprising:
the information processing device according to claim 1;
a message processing device configured to receive a message in which the transmission destination is specified and transmit to the information processing device; and
an information providing device configured to transmit, to the information processing device, the inquiry related to the target specialty, and provide a search result indicating the user searched by the information processing device.

9. An information processing system, comprising:
the information processing device according to claim 1;
a mail acquisition device configured to acquire the message from a terminal that is used to send the message to the transmission destination and transmit the message to the information processing device; and
an information providing device configured to transmit, to the information processing device, the inquiry related to the target specialty, and provide a search result indicating the user searched by the information processing device.

10. A non-transitory recording medium storing a plurality of instructions which, when executed by one or more processors, cause the processors to perform a method, comprising:
acquiring a message to be transmitted to a transmission destination and user information of the transmission destination;
obtaining a piece of information indicating a specialty from the message;
storing, in a memory, the piece of information indicating the specialty in association with the user information of the transmission destination; and
searching for a user, in response to an inquiry related to a target specialty and according to content of the inquiry, based on one or more pieces of information indicating one or more specialties including the piece of information indicating the specialty, the one or more pieces of information being previously stored in the memory.
